(19) United States
(12) Patent Application Publication
(10) Pub. No.: US 2026/0276321 A1
(43) Pub. Date: Sep. 17, 2026

(54) OPTIMIZED RECOVERY OF COMPRESSED OR LIQUID GAS REFUELING HEAT ENERGY

(71) Applicant: VOLVO TRUCK CORPORATION, Göteborg (SE)

(72) Inventors: Oscar Stjernberg, Göteborg (SE); Martin Wilhelmsson, Torslanda (SE)

(21) Appl. No.: 19/168,727

(22) PCT Filed: Mar. 29, 2023
(86) PCT No.: PCT/IB2023/053148

§ 371 Date: Sep. 24, 2025

(51) Int. Cl. F28D 21/00; F17C 1/00; G01K 3/00; G01K 7/02; G01L 19/00

(52) U.S. Cl. CPC F28D 21/00; F17C 1/00; G01K 3/005; G01K 7/02; G01L 19/0092; F17C 2227/03; F28D 2021/0047

(57) ABSTRACT

A method to recover heat energy associated with a refueling process in a vehicle having a compressed hydrogen or natural gas (CNG or H2) fuel tank includes activating a heat energy recovery system to recover heat energy associated with the refueling process. The method includes directing recovered heat energy to at least one vehicle component in preparation of vehicle starting. The method includes deactivating the heat energy recovery system responsive to the pressure in the CNG or H2 fuel tank reaching a maximum pressure limit.

### TECHNICAL FIELD

The disclosure relates generally to vehicle heat energy recovery. In particular aspects, the disclosure relates to optimizing recovery of compressed or liquid gas refueling heat energy. The disclosure can be applied in heavy-duty vehicles, such as trucks, buses, and construction equipment. Although the disclosure may be described with respect to a particular vehicle, the disclosure is not restricted to any particular vehicle.

### BACKGROUND

A conventional refueling process of a compressed natural gas (CNG) or hydrogen (H2) fuel tank is shown in FIG. 1. In FIG. 1, axis 10 is pressure, axis 12 is temperature, and axis 14 is time. Line 16 represents ambient temperature and line 18 represents maximum pressure limit of the CNG or H2 fuel tank. Line 20 represents pressure as and line 22 represents temperature as the CNG or H2 fuel tank is refueled. It can be seen how the pressure increases as gas is being added. Due to the pressure buildup, the temperature in the CNG or H2 fuel tank also increases. The increase in pressure and temperature in the CNG or H2 fuel tank results in a large amount of heat being generated. When the pressure in the CNG or H2 fuel tank reaches the maximum pressure limit 18, refueling is stopped. Due to the ambient temperature being colder than the tank temperature, the temperature of the fuel tank is decreased over time. The decrease in temperature also decreases the pressure in the fuel tank according to the “the ideal gas law:”

$$P = \frac{n R T}{V}$$

where P is pressure, n is moles of gas, R is ideal gas constant, Tis temperature and V is volume. As a result, the amount of CNG or H2 in the fuel tank falls below the maximum pressure limit 18 leaving the gas (CNG or H2) in the fuel tank further below the maximum pressure limit than the gas could be at. Thus, there is a need for an improved refueling process.

### SUMMARY

According to a first aspect of the disclosure, a method to recover heat energy associated with a refueling process in a vehicle having a compressed hydrogen or natural gas fuel tank includes activating a heat recovery system to recover heat energy associated with the refueling process. The method includes directing recovered heat energy to at least one vehicle component in preparation of vehicle starting. The method includes deactivating the heat recovery system responsive to the pressure in the compressed hydrogen or natural gas fuel tank reaches a maximum pressure limit. The first aspect of the disclosure may seek to recover heat energy and enable the CNG or H2 tank to be closer to the maximum pressure limit after refueling. A technical benefit may include using the recovered heat energy to heat vehicle components that operate better when warmed up.

In some examples, the method includes determining when one of a pressure in the compressed hydrogen or natural gas fuel tank rises above a pressure threshold during the refueling process or a temperature in the compressed hydrogen or natural gas fuel tank rises above a temperature threshold above ambient temperature. The method includes responsive to the one of the pressure raised above the pressure threshold or the temperature reaches the temperature threshold, activating the heat recovery system to recover heat energy associated with the refueling process. A technical benefit may include using the recovered heat energy to heat vehicle components that operate better when warmed up.

In some examples, directing the recovered heat energy to at least one vehicle component in preparation of vehicle starting comprises directing the recovered heat energy to the at least one vehicle component while maintaining the compressed hydrogen or natural gas fuel tank at a temperature the compressed hydrogen or natural gas fuel tank was at when the heat recovery system was activated. A technical benefit may include keeping the temperature in the tank from causing an increase in CNG or H2 pressure in the tank, thereby enabling the CNG or H2 tank to be refueled closer to the maximum pressure limit.

In some examples, the method includes stopping the refueling process when the pressure in the compressed hydrogen or natural gas tank reaches the maximum pressure limit. A technical benefit may include keeping the CNG or H2 tank from having a pressure above the maximum pressure limit.

In some examples, the method includes starting the refueling process when the vehicle is in a cold state. A technical benefit may include maximizing the amount of heat energy that can be recovered.

In some examples, the at least one vehicle component includes one or more of a battery, a selective catalytic reduction unit, an engine, a fuel cell, a cabin heater, and a diesel exhaust fluid supply.

In some examples, the method includes determining which vehicle component of the at least one vehicle component in which to direct the recovered heat energy. A technical benefit may include allowing the vehicle user, fleet manager, vehicle manufacturer, the ability to specify which vehicle component or components will receive the recovered heat energy, thereby enabling the use of the recovered heat energy to be optimized.

In some examples, determining which vehicle component of the at least one vehicle component in which to direct the recovered heat energy includes determining an order in which vehicle components of the at least one vehicle component is provided recovered heat energy. A technical benefit may include heating vehicle components that operate more efficiently when warmer, thereby increasing efficiency of the vehicle coolant system.

In some examples, directing recovered heat energy to the at least one vehicle component includes directing recovered heat energy in parallel to a plurality of the at least one vehicle component. A technical benefit may include allowing the vehicle user, fleet manager, vehicle manufacturer, the ability to specify which vehicle component or components will receive the recovered heat energy, thereby enabling the use of the recovered heat energy to be optimized.

In some examples, directing recovered heat energy to the at least one vehicle component includes directing recovered heat energy serially to a plurality of the at least one vehicle component. A technical benefit may include allowing the vehicle user, fleet manager, vehicle manufacturer, the ability to prioritize which vehicle component or components will receive the recovered heat energy, thereby enabling the use of the recovered heat energy to be optimized.

In some examples, the compressed hydrogen or natural gas fuel tank is a plurality of compressed hydrogen or natural gas fuel tanks. A technical benefit may include recovering heat energy from each CNG of H2 tank on a vehicle, thereby increasing the amount of heat energy recovered.

According to a second aspect of the disclosure, a heat energy recovery system of a vehicle having at least one compressed hydrogen or natural gas fuel tank includes a heat exchanger configured to recover heat energy associated with a refueling process. The heat energy recovery system further includes a heat energy recovery system controller configured to: activate a heat recovery system to recover, via the heat exchanger, heat energy associated with the refueling process; direct recovered heat energy to at least one vehicle component in preparation of vehicle starting; and deactivate the heat recovery system responsive to the pressure in the compressed hydrogen or natural gas fuel tank reaches a maximum pressure limit. The second aspect of the disclosure may seek to recover heat energy and enable the CNG or H2 tank to be closer to the maximum pressure limit after refueling. A technical benefit may include using the recovered heat energy to heat vehicle components that operate better when warmed up.

In some examples, in activating the heat recovery system, the heat energy recovery system controller is configured to: determine when one of a pressure in the compressed hydrogen or natural gas fuel tank raises above a pressure threshold during the refueling process or a temperature in the compressed hydrogen or natural gas fuel tank reaches a temperature threshold above ambient temperature; responsive to the one of the pressure raised above the pressure threshold or the temperature reaches the temperature threshold, activating the heat recovery system. A technical benefit may include using the recovered heat energy to heat vehicle components that operate better when warmed up.

In some examples, in directing the recovered heat energy to at least one vehicle component in preparation of vehicle starting, the heat energy recovery system controller is further configured to direct the recovered heat energy to the at least one vehicle component while maintaining the at least one compressed hydrogen or natural gas fuel tank at a temperature the compressed hydrogen or natural gas fuel tank was at when the heat recovery system was activated. A technical benefit may include keeping the temperature in the tank from causing an increase in CNG or H2 pressure in the tank, thereby enabling the CNG or H2 tank to be refueled closer to the maximum pressure limit.

In some examples, the heat energy recovery system controller is further configured to stop the refueling process when the pressure in the compressed hydrogen or natural gas tank reaches the maximum pressure limit. A technical benefit may include keeping the CNG or H2 tank from having a pressure above the maximum pressure limit.

In some examples, the heat energy recovery system controller is further configured to utilize the heat exchanger during a refueling process when the vehicle is in a cold state. A technical benefit may include maximizing the amount of heat energy that can be recovered.

In some examples, the at least one vehicle component includes one or more of a battery, a selective catalytic reduction unit, an engine, a fuel cell, a cabin heater, and a diesel exhaust fluid supply. A technical benefit may include allowing the vehicle user, fleet manager, vehicle manufacturer, the ability to specify which vehicle component or components will receive the recovered heat energy, thereby enabling the use of the recovered heat energy to be optimized.

In some examples, the heat energy recovery system controller is further configured to determine which vehicle component of the at least one vehicle component in which to direct the recovered heat energy. A technical benefit may include heating vehicle components that operate more efficiently when warmer, thereby increasing efficiency of the vehicle coolant system.

In some examples, in determining which vehicle component of the at least one vehicle component in which to direct the recovered heat energy, the heat energy recovery system controller is further configured to determine an order in which vehicle components of the at least one vehicle component is provided recovered heat energy. A technical benefit may include allowing the vehicle user, fleet manager, vehicle manufacturer, the ability to specify which vehicle component or components will receive the recovered heat energy, thereby enabling the use of the recovered heat energy to be optimized.

In some examples, in directing recovered heat energy to the at least one vehicle component, the heat energy recovery system controller is further configured to direct recovered heat energy in parallel to a plurality of the at least one vehicle component. A technical benefit may include allowing the vehicle user, fleet manager, vehicle manufacturer, the ability to specify which vehicle component or components will receive the recovered heat energy, thereby enabling the use of the recovered heat energy to be optimized.

In some examples, in directing recovered heat energy to the at least one vehicle component, the heat energy recovery system controller is further configured to direct recovered heat energy serially to a plurality of the at least one vehicle component. A technical benefit may include allowing the vehicle user, fleet manager, vehicle manufacturer, the ability to prioritize which vehicle component or components will receive the recovered heat energy, thereby enabling the use of the recovered heat energy to be optimized.

In some examples, the heat energy recovery system is comprised in a vehicle controller of the vehicle.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

The accompanying drawings, which are included to provide a further understanding of the disclosure and are incorporated in and constitute a part of this application, illustrate certain non-limiting examples of the disclosure.

Figure is a graphical illustration of a conventional refueling process of a compressed natural gas or hydrogen fuel tank according to one example.

FIGS. 2A-2B are an example of an operating environment in which the heat energy recovery system can be implemented within according to one example.

FIG. 3 is a graphical illustration of a refueling process according to one example.

FIG. 4 is an illustration of recovering heat energy during refueling of a CNG or H2 fuel tank according to one example.

FIGS. 5-8 are flowcharts of operations the heat energy recovery system controller performs according to examples.

FIGS. 9A-9C illustrate examples of heat exchangers that can be used according to one example.

FIG. 10 is a graphical illustration of a refueling process according to another example.

FIG. 11 is a schematic diagram of an exemplary computer system for implementing the heat energy recovery system controller disclosed herein, according to one example.

### DETAILED DESCRIPTION

Aspects set forth below represent the necessary information to enable those skilled in the art to practice the disclosure.

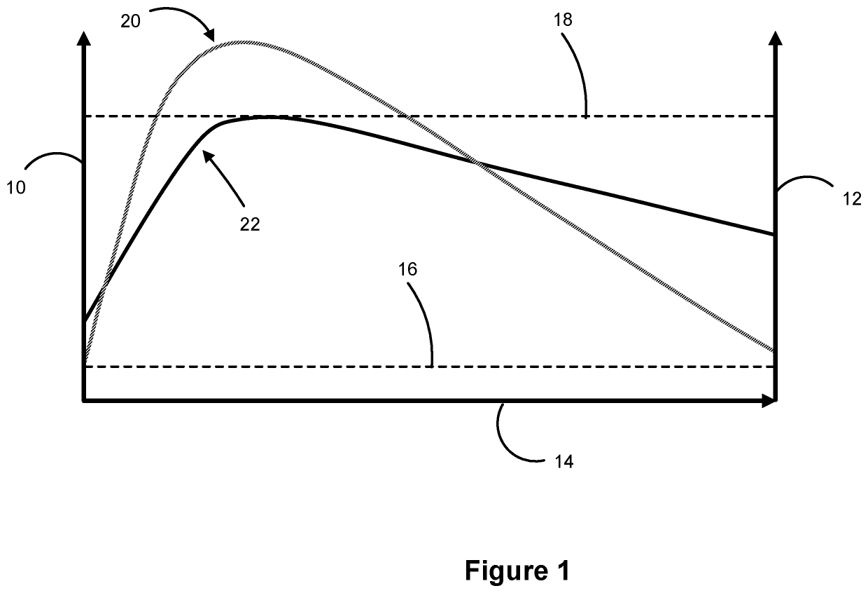

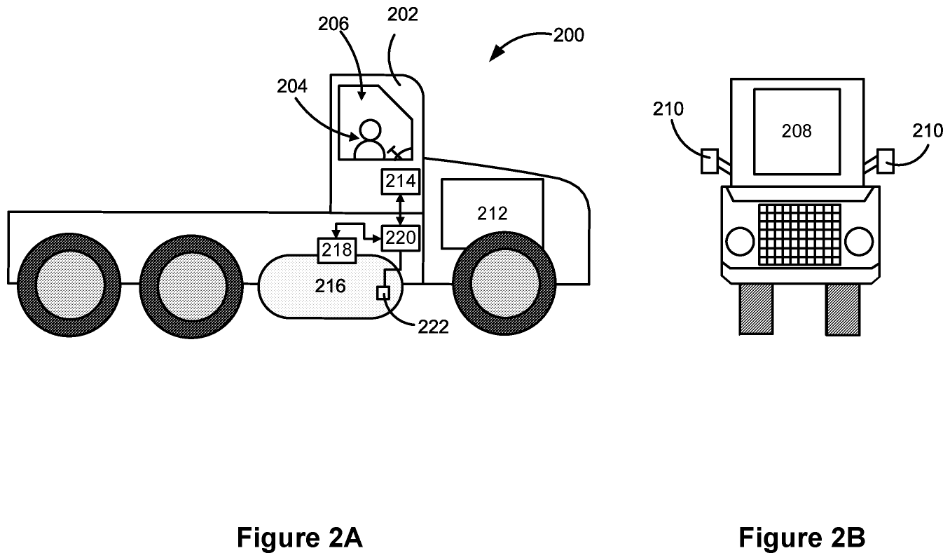

FIG. 2 illustrates an environment in which the heat energy recovery system can be implemented. Turning to FIG. 2, a vehicle 100, such as a truck, having a cab 202 used by a vehicle user 204 sitting in the interior 206 of the cab is shown. The cab 206 has a windshield 208 and outside rear view mirrors 210. The vehicle has an engine 212 controlled by a vehicle controller 214. The CNG or H2 fuel tank 216 has a heat exchanger 218 associated with the CNG or H2 fuel tank 216 where the heat exchanger 218 is controlled by a heat energy recovery system controller 220. The heat energy recovery system controller may be a stand-alone controller or be part of the vehicle controller 214. The heat energy recovery system controller 220 uses the heat exchanger 218 and sensors 222 in recovering heat energy. The sensors 222 may include a temperature sensor (e.g., a thermocouple) and a pressure sensor.

As previously described, when the CNG or H2 fuel tank reaches a maximum pressure, refueling is stopped. Due to the ambient temperature being colder than the CNG or H2 fuel tank temperature, the temperature of the CNG or H2 fuel tank is decreased over time. The decrease in temperature also decreases the pressure in the CNG or H2 fuel tank. This results in leaving the gas (CNG or H2) in the CNG or H2 fuel tank further below the maximum pressure limit than the gas could be at.

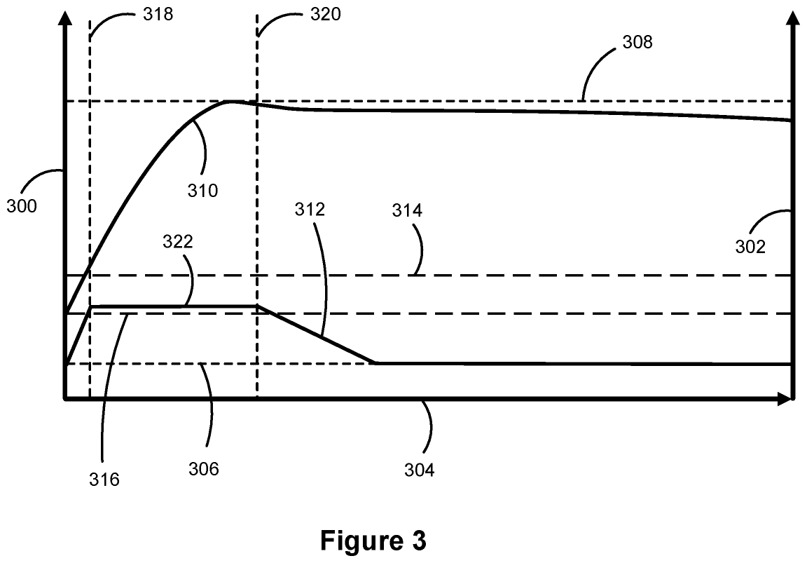

By recovering the heat energy generated, the temperature of the CNG or H2 fuel tank 216 can be held at lower temperatures thus resulting in more moles of gas that can be added to the CNG or H2 fuel tank 216. This is illustrated in FIG. 3. The recovered heat energy can then be used for heating of other systems such as heating of the vehicle's cabin, the engine, exhaust aftertreatment systems (EATS), batteries, the windshield, the outside rear view mirrors, the selective catalytic reduction unit (SCR), sensors, etc.

FIG. 3 illustrates graphically how heat energy generated from refueling can be recovered with a heat exchanger together with the CNG or H2 fuel tank during refueling as explained below. Turning to FIG. 3, axis 300 is pressure, axis 302 is temperature, and axis 304 is time. Line 306 represents ambient temperature and line 308 represents a maximum pressure limit of the CNG or H2 fuel tank. Line 310 represents pressure in the tank and line 312 represents temperature in the tank. Line 314 represents a pressure threshold and line 316 represents a temperature threshold. Line 318 represents a start of heat recovery and line 320 represents stoppage of heat recovery.

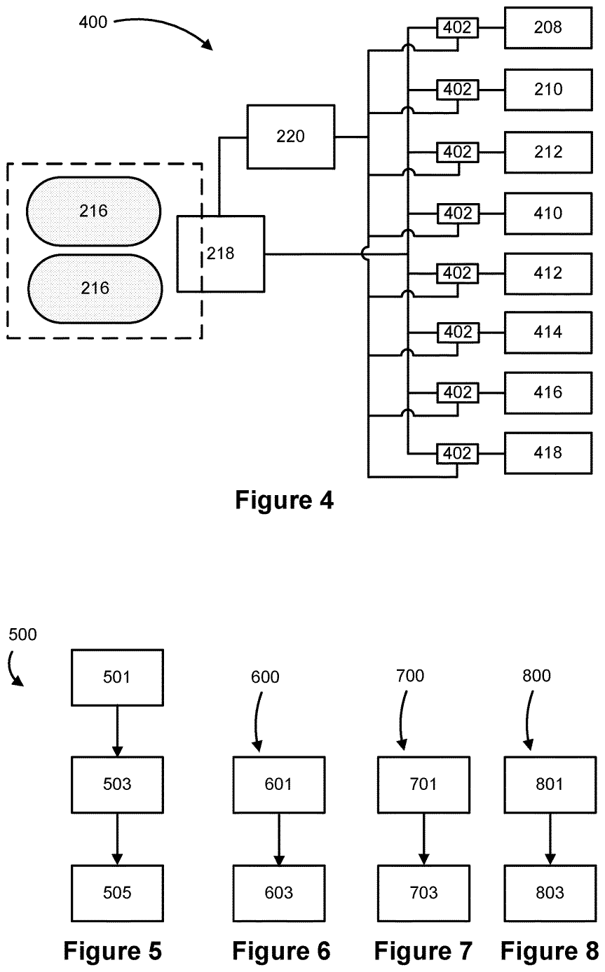

FIG. 4 illustrates components of a heat energy recovery system 400 according to an example and some of the vehicle components that can be heated with the recovered heat energy. The heat energy recovery system 400 includes the heat exchanger 218, the heat energy recovery system controller 220 and valves 402 to direct recovered heat to the vehicle components. While valves 402 are shown, other ways of directing the recovered heat to vehicle components may be used. For example, if only a few components are used, then no valves 402 are needed. In other scenarios, some vehicle components may be “hardwired” to the recovered heat to always receive the recovered heat so that no valve 402 is used while valves 402 may be used with other components. If vehicle components are always to receive the recovered heat, then no valves are needed and all vehicle components to receive the recovered heat receive the recovered heat energy in parallel. In one aspect, fluid conduits are used to direct the heat to the vehicle components. In another aspect, air conduits are used to direct the heat to the vehicle components. One or more valves (not shown) may be used to control the fluid or air flowing through the heat exchanger 218. This enables the heat energy recovery system controller 220 to turn off fluid or air flowing through the heat exchanger during vehicle operation.

The vehicle components that may receive the recovered heat may include the windshield 208 (when needed to defrost the windshield), outside rear view mirrors 210 (when needed to defrost the mirrors), engine 212 (e.g., during extreme cold start conditions), one or more batteries 410, a selective catalytic reduction unit 412, a fuel cell 414, a cabin heater 416, and a diesel exhaust fluid supply 418. Other vehicles components may include the vehicle's cabin 206, exhaust aftertreatment systems (EATS), sensors, etc.

FIG. 5 illustrates operations 500 the heat energy recovery system controller 220 performs in an example. The operations 500 include determining when one of a pressure 310 in the compressed hydrogen or natural gas fuel tank 216 rises above a pressure threshold 316 during the refueling process or a temperature 312 in the compressed hydrogen or natural gas fuel tank 216 rises above a temperature threshold 314 above ambient temperature 306 (Block 501). The heat energy recovery system controller 220 uses sensors 222 to determine the pressure and temperature of the CNG or H2 fuel tank 216.

The operations 500 further includes responsive to the one of the pressure 310 rises above the pressure threshold 316 or the temperature 312 rises above the temperature threshold 314, activating a heat energy recovery system 400 to recover heat energy associated with the refueling process (Block 503). This is illustrated in FIG. 3 by line 318. The heat energy is recovered via heat exchanger 218.

The operations 500 further include directing recovered heat energy to at least one vehicle component in preparation of vehicle starting (Block 505). Directing the recovered heat energy to at least one vehicle component in preparation of vehicle starting comprises directing the recovered heat energy to the at least one vehicle component while maintaining the compressed hydrogen or natural gas fuel tank at a temperature 322 the compressed hydrogen or natural gas fuel tank 216 was at when the heat recovery system was activated 318.

The operations 500 further includes deactivating the heat recovery system 400 responsive to the pressure in the compressed hydrogen or natural gas fuel tank 216 reaches a maximum pressure limit 308. This is illustrated in FIG. 3 by line 320.

FIG. 7 illustrates operations 700 the heat energy recovery system controller 220 performs in another example. The operations 700 include stopping the refueling process when the pressure in the compressed hydrogen or natural gas tank 216 reaches the maximum pressure limit 308 (Block 701).

To maximize the amount of heat energy recovered, the refueling process is started when the vehicle is in a cold start. Thus, operations 700 include starting the refueling process when the vehicle is in a cold state (Block 703). The heat energy recovery system controller 220 is further configured to utilize the heat exchanger 218 during a refueling process when the vehicle 200 s in a cold state.

FIG. 8 illustrates operations 800 the heat energy recovery system controller 220 performs in a further example. The operations 800 include determining which vehicle component of the at least one vehicle component in which to direct the recovered heat energy (Block 801). As indicated above, the at least one vehicle component can be the windshield 208 (when needed to defrost the windshield), outside rear view mirrors 210 (when needed to defrost the mirrors), engine 212 (e.g., during extreme cold start conditions), one or more batteries 410, a selective catalytic reduction unit 412, a fuel cell 414, a cabin heater 416, and a diesel exhaust fluid supply 418. Other vehicles components may include the vehicle's cabin 206, exhaust aftertreatment systems (EATS), sensors, etc.

The operations 800 include determining an order in which vehicle components of the at least one vehicle component is provided recovered heat energy (Block 803).

The order can include directing recovered heat energy in parallel to a plurality of the at least one vehicle component, directing recovered heat energy serially to a plurality of the at least one vehicle component, or directing recovered heat energy in parallel and serially to a plurality of the at least one vehicle component.

In some cases, the vehicle manufacturer and/or a fleet manager of vehicles may be set a default list of vehicle components. The default list in one example can be changed by a driver. For example, during extreme cold conditions where the windshield and/or outside rear view mirrors need to be defrosted, a driver of the vehicle may be able to change where the directed heat flows to flow to the windshield and/or outside rear view mirrors.

To activate the heat energy recovery system 400, the heat energy recovery system controller 220 activates the heat exchanger 218 and when used, the appropriate valves 402. The heat energy recovery system controller 220 may control one compressed hydrogen or natural gas fuel tank or a plurality of compressed hydrogen or natural gas fuel tanks.

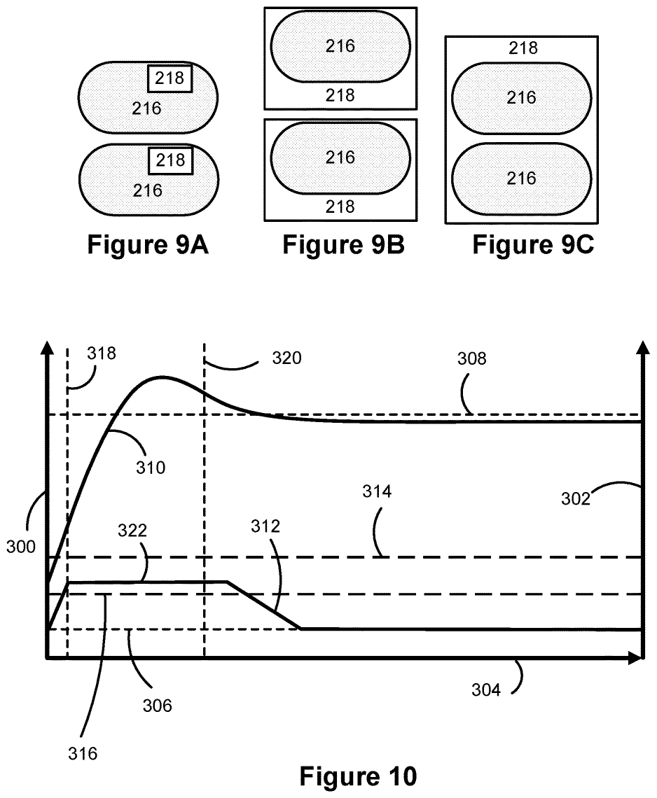

In order to recover the heat energy during refueling, the heat energy recovery system controller 220 obtains the pressure and temperature in the CNG or H2 tank from the sensors 222. The heat energy recovery system controller 220 controls the heat exchanger 218 to recover the heat energy. The heat exchanger can be integrated into the GNC or H2 tank as illustrated in FIG. 9A. The output (i.e., heated air) from the heat exchanger is provided to the at least one vehicle component as described above.

In another example, the heat exchanger 218 can surround a CNG or H2 fuel tank 216 as illustrated in FIG. 9B. This may be done when the CNG or H2 fuel tank is too small to fit the heat exchanger 218. In a further example, the heat exchanger 218 can surround a plurality of CNG or H2 fuel tanks 216 as illustrated in FIG. 9C.

FIG. 10 illustrates an example where additional heat can be recovered by the heat energy recovery system controller 220 allowing the pressure to rise above the maximum pressure limit 308 for a brief period of time knowing that the pressure will fall as the temperature in the CNG or H2 fuel tank 216 falls to ambient temperature.

In an example, a prediction model may be used to optimize refueling and heat recovery. For example, the heat energy recovery system controller 220 can over time track the conditions when refueling is done, driving characteristics (e.g., length of routes) and how much heat energy has been recovered. Using this data, the heat energy recovery system controller 220 can determine the optimal conditions to recover the most heat energy and provide this data to the driver and/or fleet manager. The driver and/or fleet manager can then use the data to refuel the CNG or H2 fuel tank(s)

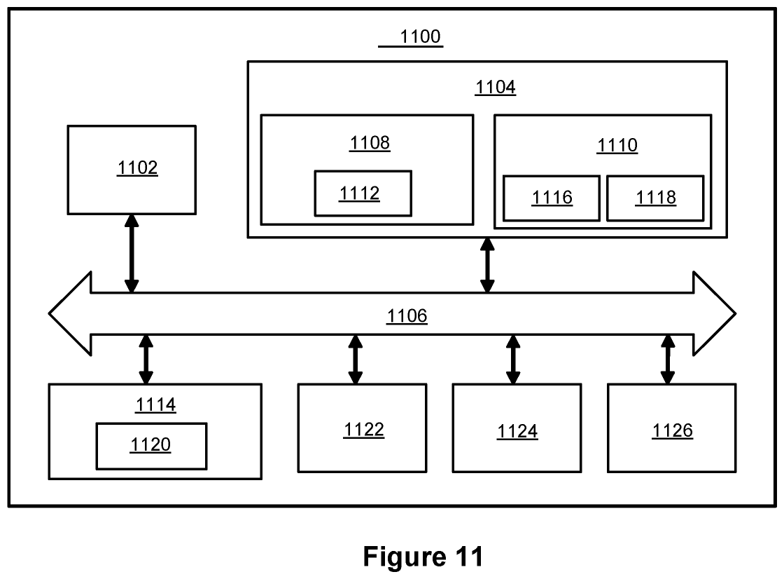

FIG. 11 is a schematic diagram of a computer system 1100 for implementing examples disclosed herein. The computer system 1100 is adapted to execute instructions from a computer-readable medium to perform these and/or any of the functions or processing described herein. The computer system 1100 may be connected (e.g., networked) to other machines in a LAN, an intranet, an extranet, or the Internet. While only a single device is illustrated, the computer system 1100 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 1100 may comprise at least one computing device or electronic device capable of including firmware, hardware, and/or executing software instructions to implement the functionality described herein. The computer system 1100 may include a processor device 1102 (may also be referred to as a control unit), a memory 1104, and a system bus 1106. The computer system 1100 may include at least one computing device having the processor device 1102. The system bus 1106 provides an interface for system components including, but not limited to, the memory 1104 and the processor device 1102. The processor device 1102 may include any number of hardware components for conducting data or signal processing or for executing computer code stored in memory 1104. The processor device 1102 (e.g., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 1106 may be any of several types of bus structures that may further interconnect to a memory bus (with or without a memory controller), a peripheral bus, and/or a local bus using any of a variety of bus architectures. The memory 1104 may be one or more devices for storing data and/or computer code for completing or facilitating methods described herein. The memory 1104 may include database components, object code components, script components, or other types of information structure for supporting the various activities herein. Any distributed or local memory device may be utilized with the systems and methods of this description. The memory 1104 may be communicably connected to the processor device 1102 (e.g., via a circuit or any other wired, wireless, or network connection) and may include computer code for executing one or more processes described herein. The memory 1104 may include non-volatile memory 1108 (e.g., read-only memory (ROM), erasable programmable read-only memory (EPROM), electrically erasable programmable read-only memory (EEPROM), etc.), and volatile memory 1110 (e.g., random-access memory (RAM)), or any other medium which can be used to carry or store desired program code in the form of machine-executable instructions or data structures and which can be accessed by a computer or other machine with a processor device 1102. A basic input/output system (BIOS) 1112 may be stored in the non-volatile memory 1108 and can include the basic routines that help to transfer information between elements within the computer system 1100.

The computer system 1100 may further include or be coupled to a non-transitory computer-readable storage medium such as the storage device 1114, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 1014 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 1114 and/or in the volatile memory 1110, which may include an operating system 1116 and/or one or more program modules 1118. All or a portion of the examples disclosed herein may be implemented as a computer program product 1120 stored on a transitory or non-transitory computer-usable or computer-readable storage medium (e.g., single medium or multiple media), such as the storage device 1114, which includes complex programming instructions (e.g., complex computer-readable program code) to cause the processor device 1002 to carry out the steps described herein. Thus, the computer-readable program code can comprise software instructions for implementing the functionality of the examples described herein when executed by the processor device 1102. The processor device 1102 may serve as a controller or control system for the computer system 1100 that is to implement the functionality described herein.

The computer system 1100 also may include an input device interface 1122 (e.g., input device interface and/or output device interface). The input device interface 1122 may be configured to receive input and selections to be communicated to the computer system 1100 when executing instructions, such as from a keyboard, mouse, touch-sensitive surface, etc. Such input devices may be connected to the processor device 1102 through the input device interface 1122 coupled to the system bus 1106 but can be connected through other interfaces such as a parallel port, an Institute of Electrical and Electronic Engineers (IEEE) 1394 serial port, a Universal Serial Bus (USB) port, an IR interface, and the like. The computer system 1000 may include an output device interface 1124 configured to forward output, such as to a display, a video display unit (e.g., a liquid crystal display (LCD) or a cathode ray tube (CRT)). The computer system 1100 may also include a communications interface 1126 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A method to recover heat energy associated with a refueling process in a vehicle having a compressed hydrogen or natural gas fuel tank, the method comprising:
activating a heat energy recovery system comprising a heat exchanger to recover heat energy associated with the refueling process;
directing recovered heat from the heat exchanger to at least one vehicle component in preparation of vehicle starting; and
deactivating the heat energy recovery system responsive to pressure in the compressed hydrogen or natural gas fuel tank reaching a maximum pressure limit.

2. The method of claim 1, wherein activating the heat energy recovery system comprises:
determining when one of a pressure in the compressed hydrogen or natural gas fuel tank raises above a pressure threshold during the refueling process or a temperature in the compressed hydrogen or natural gas fuel tank reaches a temperature threshold above ambient temperature; and
responsive to the one of the pressure raises above the pressure threshold or the temperature reaches the temperature threshold, activating the heat energy recovery system.

3. The method of claim 2, wherein directing the recovered heat energy to at least one vehicle component in preparation of vehicle starting comprises directing the recovered heat energy to the at least one vehicle component while maintaining the compressed hydrogen or natural gas fuel tank at a temperature the compressed hydrogen or natural gas fuel tank was at when the heat energy recovery system was activated.

4. The method of claim 2, further comprising stopping the refueling process when the pressure in the compressed hydrogen or natural gas tank reaches the maximum pressure limit.

5. The method of claim 1, further comprising starting the refueling process when the vehicle is in a cold state.

6. The method of claim 1, wherein the at least one vehicle component comprises one or more of a battery, a selective catalytic reduction unit, an engine, a fuel cell, a cabin heater, and a diesel exhaust fluid supply.

7. The method of claim 1, further comprising determining which vehicle component of the at least one vehicle component in which to direct the recovered heat energy.

8. The method of claim 7, wherein determining which vehicle component of the at least one vehicle component in which to direct the recovered heat energy comprises determining an order in which vehicle components of the at least one vehicle component is provided recovered heat energy.

9. The method of claim 7, wherein directing recovered heat energy to the at least one vehicle component comprises directing recovered heat energy in parallel to a plurality of the at least one vehicle component.

10. The method of claim 7, wherein directing recovered heat energy to the at least one vehicle component comprises directing recovered heat energy serially to a plurality of the at least one vehicle component.

11. A heat energy recovery system of a vehicle having at least one compressed hydrogen or natural gas fuel tank, the heat energy recovery system comprising:
a heat exchanger (218) configured to recover heat energy associated with a refueling process; and
a heat energy recovery system controller configured to:
activate a heat energy recovery system comprising the heat exchanger to recover, via the heat exchanger, heat energy associated with the refueling process;
direct recovered heat energy from the heat exchanger (218) to at least one vehicle component in preparation of vehicle starting; and
deactivate the heat energy recovery system responsive to pressure in the compressed hydrogen or natural gas fuel tank reaching a maximum pressure limit.

12. The heat energy recovery system of claim 11, wherein in activating the heat energy recovery system, the heat energy recovery system controller is further configured to:
determine when one of a pressure in the compressed hydrogen or natural gas fuel tank raises above a pressure threshold during the refueling process or a temperature in the compressed hydrogen or natural gas fuel tank reaches a temperature threshold above ambient temperature; and
responsive to the one of the pressure raised above the pressure threshold or the temperature reaches the temperature threshold, activate the heat energy recovery system.

13. The heat energy recovery system of claim 11, wherein in directing the recovered heat energy to at least one vehicle component in preparation of vehicle starting, the heat energy recovery system controller is further configured to direct the recovered heat energy to the at least one vehicle component while maintaining the at least one compressed hydrogen or natural gas fuel tank at a temperature the compressed hydrogen or natural gas fuel tank was at when the heat energy recovery system was activated.

14. The heat energy recovery system of claim 11, wherein the heat energy recovery system controller (220) is further configured to utilize the heat exchanger during a refueling process when the vehicle (200) is in a cold state.

15. The heat energy recovery system of claim 11, wherein the at least one vehicle component comprises one or more of a battery, a selective catalytic reduction unit, an engine, a fuel cell, a cabin heater, and a diesel exhaust fluid supply.

16. The heat energy recovery system of claim 11, the heat energy recovery system controller is further configured to determine which vehicle component of the at least one vehicle component in which to direct the recovered heat energy.

17. The heat energy recovery system of claim 16, wherein in determining which vehicle component of the at least one vehicle component in which to direct the recovered heat energy, the heat energy recovery system controller is further configured to determine an order in which vehicle components of the at least one vehicle component is provided recovered heat energy.

18. The heat energy recovery system of claim 16, wherein in directing recovered heat energy to the at least one vehicle component, the heat energy recovery system controller is further configured to direct recovered heat energy in parallel to a plurality of the at least one vehicle component.

19. The heat energy recovery system of claim 16, wherein in directing recovered heat energy to the at least one vehicle component, the heat energy recovery system controller is further configured to direct recovered heat energy serially to a plurality of the at least one vehicle component.

20. The heat energy recovery system of claim 11 wherein the heat energy recovery system is comprised in a vehicle.
